(19) United States
(12) Patent Application Publication
(10) Pub. No.: US 2006/0105778 A1
(43) Pub. Date: May 18, 2006

(54) Frequency allocation in a radio system

(76) Inventor: Felix Wiederspahn, Senden (DE)

Correspondence Address: JANSSON, SHUPE, MUNGER & ANTARAMIAN, LTD, 245 MAIN STREET, RACINE, WI, 53403, US

(21) Appl. No.: 11/265,915

(22) Filed: Nov. 3, 2005

(30) Foreign Application Priority Data
Nov. 4, 2004 (EP) 04 026 175.2

(51) Int. Cl. H04Q 7/20

(52) U.S. Cl. 455/456.1; 455/450

(57) ABSTRACT

In a method of selecting a radio channel from a plurality of radio channels comprised in a frequency plan and assigning the selected radio channel to a mobile radio station in consideration of the current geographic location of the mobile radio station which is provided with memory means storing data representative of the frequency plan and of geographic locations in association with one another, the mobile radio station determines its current geographic location and dependent on its current geographic location bars the data of predetermined radio channels from the plurality of radio channels from being selected for use by the mobile radio station, and said mobile radio station selects one of the other radio channels the data of which are not barred within the memory and assigns same for use to at least itself.

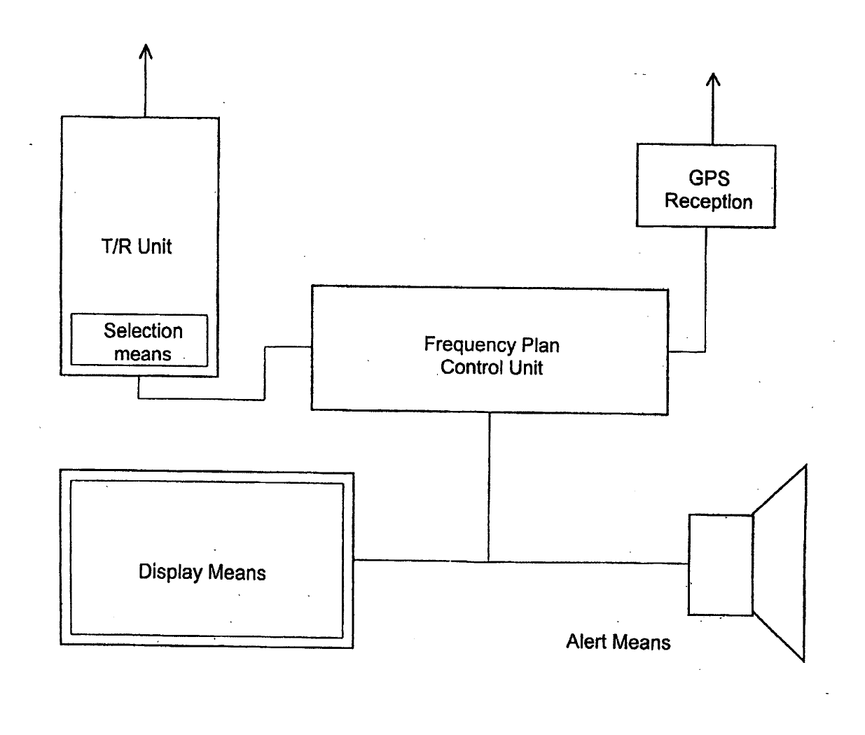

### RELATED APPLICATION

This application claims the benefit of EP 04 026 175.2, filed Nov. 4, 2004, the contents of which are incorporated herein.

### FIELD OF THE INVENTION

The present invention relates to a method for selecting a radio frequency from a plurality of radio frequencies comprised in a frequency plan and for allocating the selected radio frequency to at least one mobile station and to a mobile radio station carrying out such method.

### BACKGROUND OF THE INVENTION

In today's trunked radio systems like GSM, TETRA (=TErrestrial Trunked RAdio) and TETRAPOL, mobile stations are operated as subscriber stations in a network governed by stationary base stations. When those mobile stations are in communication with a stationary network, they communicate via radio links with the stationary base stations. In this situation, the radio frequency channels, in the following “radio channels”, used by the mobile stations are selected by the base stations and allocated from there to the mobile stations, without the current location of the respective mobile station being taken into consideration.

On the other hand, there are modes of operation in which the user of a mobile station, usually after having checked the frequency band as to a free radio channel or on the basis of a corresponding appointment with a communication partner, decides which radio channel he wants to use. This is the case in the so-called direct mode in which a radio communication is established without engagement of a stationary infrastructure.

In GB 2 282 299 A a frequency allocation system in a cellular radio system is disclosed in which a number of base sites are connected to a CPU. The CPU has a database containing base site location and frequency allocation information. The location information of a new base unit is derived from a GPS receiver and sent to the CPU. This information is compared with known location and frequency allocation information for other base sites, and the new base unit and the other base sites are controlled to adapt new frequency as a result of the comparison, thereby automatically modifying and updating the frequency allocation plan. This system necessarily uses a central station for the control of the whole system.

Often, the radio channels admitted for a radio communication in the direct mode are dependent on the respective geographic area, for instance as neighbour states must share the available frequency band at their common borders. When selecting a radio channel, on one hand the radio stations located in the centre of their own territory do not need to take problems into consideration which are existent in the area of the borders only, on the other hand the same radio stations are mobile throughout their own territory so that in the area of the borders interferences with radio services of the neighbour country may arise if a proper radio channel selection is not taken into consideration. In order to prevent that such stations which are mobile throughout the own territory may get in conflict with the radio services in the neighbour country when approaching the border area, those mobile stations usually use exclusively those radio channels of the frequency plan which in coordination with the authorities of the neighbour country are reserved for the own territory. However, thereby the frequency band which is available in total is not fully utilised.

The terms “territory” and “country” should not be understood as being limited to political entities, as the same situations may also arise within a country or territory which is divided in a plurality of regions in which mobile radio services are established which are independent of one another.

Further, there are situations in which within a territory stationary radio services of limited reach are established which have priority with respect to other participants, in particular mobile stations, so that it is necessary to reserve predetermined radio channels to said privileged, stationary radio services of higher priority. However, if those reserved radio channels are withheld from the mobile stations within the whole territory, i.e. also in those areas thereof which are out of the reach of the privileged, stationary radio services, an incomplete utilisation of the available frequency band results as well.

### SUMMARY OF THE INVENTION

It is therefore the object of the invention to provide a method of selecting a radio channel from a plurality of radio channels comprised in a frequency plan and for allocating the selected radio channel to at least one mobile radio station in consideration of the current geographic location of the mobile radio station.

According to the invention the mobile radio station, in the following “mobile station”, is provided with a memory device in which the frequency plan is memorised comprising radio channel data in association with geographic location data, and the mobile station itself determines its current geographic location, and dependent on the current geographic position only those predetermined radio channels within the frequency band which in accordance with the frequency plan are not reserved for other radio services at the respective geographic location are admitted for the selection from the memory device, and one of these admitted radio channels is selected by the mobile station and is assigned to at least the mobile station for being used for the radio communication.

Thus, the present invention provides a method and radio equipment in which the allocation of the radio frequency channel, in the following again “radio channel”, is dependent on the actual geographic location of the mobile station. In contrast to the prior art explained above, the allocation of the radio channel is made without use of a central installation using base stations. By means of a suitable localisation system, for instance the satellite supported system known as “GPS”, a map of radio channels accessible for the mobile station is automatically and dynamically updated in consideration of the current geographic location with the aid of the frequency plan known in the mobile station due to a memorisation in an on-board memory device of the mobile station.

In case that the mobile station is located in a territorial border area in which predetermined radio channels within the frequency band are reserved for radio services in the neighbour territory, those reserved radio channels are suppressed in the plan of frequencies which are available for the selection by the mobile station. This suppression may even comprise a total inhibition of these radio channels, so that the radio station is prevented from selecting a radio channel which is reserved for radio services within the neighbour territory.

The suppression mentioned above may be made in a manner that in a frequency map shown on a display device of the radio equipment of the mobile station, the radio channels reserved for the neighbour territory do not appear. Additionally, the radio equipment may be provided with an inhibition means which prevents that said radio channels reserved for the other radio territory can be selected at all. Said inhibition means may be controlled by a localisation means in dependency on the actual geographic location of the radio equipment, i.e. of the mobile station.

The method of the invention further enables a mobile station to access to all radio channels comprised in the frequency plan if the mobile station is located in a territorial area in which reservations for other radio services need not to be taken into consideration. Thus, if the mobile station is located e.g. in the centre of “its” territory where interferences with foreign radio services are impossible, there is total freedom to select among all radio channels available in the frequency band of concern. Thereby, the whole frequency band can optimally be utilised.

Further, the invention enables to divide a given territory in a plurality of regions in which optionally different radio channels of a common frequency plan are reserved for stationary radio services which are privileged with respect to mobile stations and are independent from one another. Those reserved radio channels are shown at or suppressed from the display in the mobile radio station in dependency on its actual geographic location and are barred from being used or are enabled, respectively.

However, it may happen that a mobile station when located far of the borders to a neighbour territory has selected a radio channel which in the border area is reserved to a radio service of a neighbour territory, so that it may not be used in the territorial border region of the own country, or has selected a radio channel that is reserved for a privileged stationery radio service within a larger territory. In order to prevent that the mobile station when approaching the territorial border area or the aforementioned larger region creates the risk of an interference with the other radio services, in accordance with a further embodiment of the present invention an alert to the user is provided dependent on the actual geographic location of the mobile station as detected by the localisation system used by the mobile station. This alert, which may be of optical or acoustic nature, should cause the user of the mobile station to leave the presently used radio channel and to select a different radio channel which doesn't cause an interference. Information as to the selection of the different radio channel may then be given in advance to the current communication partner, so that the radio communication may then be continued on the selected new radio channel without any essential interruption.

Further, it may be provided that the transmission mode on said radio channel of the alerted subscriber is barred, if the latter did not change the radio channel or leave the respective border area or region after lapse of a predetermined time period following the alert. In a preferred embodiment of the invention the control of the change of radio channel may automatically be initiated, including sending respective information as to the selected new radio channel to the communication partner in advance. Thereby, a radio communication which is practically free of any interruption may be secured.

Further details of the present invention may be derived from the following description with reference to the drawing.

### DESCRIPTION OF THE DRAWINGS

The drawing shows a block circuit diagram of a mobile radio station comprising features of the present invention and adapted to carry out the method of the invention explained above.

### DETAILED DESCRIPTION OF PREFERRED EMBODIMENTS

The mobile radio station, in the following “mobile station”, comprises an antenna to which a transmitter/receiver unit (T/R unit) is connected. The T/R unit comprises selection means for selecting a radio channel to be used in the radio communication.

The T/R unit is connected to a frequency plan control unit which comprises a memory (not shown) in which data are memorised which are representative of all radio channels which are available in the frequency band used for the radio communication. Further, the frequency plan control unit comprises a memory (not shown) in which data representative of predetermined geographic location coordinates are memorised. These data of geographic location coordinates are memorised in assignment to data of specific radio channels which are reserved for other radio services. The frequency plan control unit further comprises control means (not shown) with which selected of these radio channel data may be barred within the frequency data memory from being selected by the selection means.

The mobile station further comprises a GPS receiver which is connected to the frequency plan control unit and by means of which the current geographic location of the radio equipment may be determined. The data provided by the GPS receiver are input into the frequency plan control unit in a quasi-continuous manner, i.e. in regular intervals to update the location information for comparison purposes.

Further, display means and an acoustic alert means are provided in the mobile station, which are connected to the frequency plan control unit.

The frequency plan control unit is adapted to compare the geographic location coordinate data provided by the GPS receiver with the location coordinate data memorised in the location coordinates memory, and to bar those radio channels against accession by the selection means the location coordinate data of which match with the data provided by the GPS receiver. Further, the frequency plan control unit is adapted to control the display on the display means in a manner that the radio channels shown there do not comprise those radio channels which are not accessible for a selection by the user.

The acoustic alarm means is controlled by the frequency plan control unit in a manner that an acoustic alert is provided if during an established radio communication the ongoing comparison of the location coordinate data reveals that the mobile station moves into a location the location coordinate data of which are comprised in the location coordinates memory and the currently used radio channel matches with that which is assigned to the respective location coordinate data. Optionally, the frequency plan control unit may comprise a timer (not shown) which interrupts the radio communication after lapse of a predetermined time period after issue of the alert provided that a change of the radio channel has not been made or the mobile station did not leave the area of the location of concern in the meantime.

It may be mentioned that a plurality of privileged radio channels may be assigned to a single geographic location data in case that in a specific location interferences with a plurality of other radio services having overlapping covering areas may arise if one of those plurality of privileged radio channels is used by the mobile station when approaching said geographic location.

It is further to be understood that if the mobile station is a subscriber station in a cellular radio network, the current geographic location of the mobile station may be determined in the mobile station from data identifying the cell within which the mobile station is currently located.

I claim:

1. A method of selecting a radio channel from a plurality of radio channels comprised in a frequency plan and assigning the selected radio channel to a mobile radio station in consideration of the current geographic location of the mobile radio station, wherein the mobile radio station is provided with memory means storing data representative of the frequency plan and of geographic locations in association with one another, the mobile radio station determines its current geographic location and dependent on its current geographic location enables the data of predetermined radio channels from the plurality of radio channels to be selected for use by the mobile radio station, said predetermined radio channels only being admitted for use at the determined geographic location, and said mobile radio station selects one of said predetermined radio channels and assigns same for use to at least itself.

2. The method of selecting a radio channel from a plurality of radio channels comprised in a frequency plan and assigning the selected radio channel to a mobile radio station in consideration of the current geographic location of the mobile radio station, wherein the mobile radio station is provided with memory means storing data representative of the frequency plan and of geographic locations in association with one another, the mobile radio station determines its current geographic location and dependent on its current geographic location bars the data of predetermined radio channels from the plurality of radio channels from being selected for use by the mobile radio station, and said mobile radio station selects one of the other radio channels the data of which are not barred within the memory and assigns same for use to at least itself.

3. The method as set forth in claim 1, wherein a radio channel selection once made and assigned to the mobile radio station is updated in consideration of the current geographic location of the mobile radio station by said station itself.

4. The method as set forth in claim 2, wherein a radio channel selection once made and assigned to the mobile radio station is updated in consideration of the current geographic location of the mobile radio station by said station itself.

5. The method as set forth in claim 2, wherein alerts are created at the mobile radio station in response of the detected current geographic location.

6. The method as set forth in claim 5, wherein the radio channel assigned to the mobile radio station is inhibited in consideration of the current geographic position if the mobile radio station did not select and assign a different admissible radio channel after lapse of a predetermined time subsequent to the issue of an alert.

7. The method as set forth in claim 1, wherein the selection and assignment of a radio channel is manually made at the mobile radio station.

8. The method as set forth in claim 2, wherein the selection and assignment of a radio channel is manually made at the mobile radio station.

9. The method as set forth in claim 1, wherein the determination of the current geographic position of the mobile radio station is made by means of a satellite supported localisation system.

10. The method as set forth in claim 2, wherein the determination of the current geographic position of the mobile radio station is made by means of a satellite supported localisation system.

11. The method as set forth in claim 1, wherein the mobile radio station performs a change of the currently used radio channel in response to a change of its geographic location after having transmitted information concerning the radio channel to be used after the change to a current communication partner.

12. The method as set forth in claim 2, wherein the mobile radio station performs a change of the currently used radio channel in response to a change of its geographic location after having transmitted information concerning the radio channel to be used after the change to a current communication partner.

13. A mobile radio station, comprising a transmitter/receiver circuit which is connected to a radio channel selection means, and further comprising a frequency plan control unit and localisation means for determining the current geographic location of the mobile radio station, said localisation means being connected to the frequency plan control unit, the frequency plan control unit comprising a location coordinates memory in which data representative of predetermined geographic location coordinates are memorised in assignment to data representing radio channels, and further comprising comparison means which are adapted to compare geographic location coordinate data provided by the localisation means with the location coordinate data memorised in the memory and to bar any radio channel assigned to the memorised location coordinate data against selection by the frequency selection control means if said data match with the location coordinate data provided by the localisation means.

14. The mobile radio station as set forth in claim 13 wherein the localisation means is a receiver of a satellite supported localisation system.

15. The mobile radio station as set forth in claim 13, further comprising alert means and a timer, said timer being connected to the transceiver/receiver unit and being adapted to shut down transmission if after lapse of a predetermined time period defined by the timer after issue of an alert a change of the radio channel has not been made.

16. The mobile radio station as set forth in claim 14, further comprising alert means and a timer, said timer being connected to the transceiver/receiver unit and being adapted to shut down transmission if after lapse of a predetermined time period defined by the timer after issue of an alert a change of the radio channel has not been made.
